(19) United States
(12) Patent Application Publication
(10) Pub. No.: US 2026/0328704 A1
(43) Pub. Date: Oct. 22, 2026

(54) TEST SYSTEM

(71) Applicant: INTRAVIS GESELLSCHAFT FÜR LIEFERUNGEN UND LEISTUNGEN VON BILDGEBENDEN UND BILD, Aachen (DE)

(72) Inventors: Gerd FUHRMANN, Aachen (DE); Wolfgang JANSEN, Roetgen (DE)

(21) Appl. No.: 19/115,607

(22) PCT Filed: Oct. 23, 2023
(86) PCT No.: PCT/EP2023/079428

§ 371 Date: Mar. 26, 2025

(30) Foreign Application Priority Data
Dec. 2, 2022 (DE) 10 2022 132 095.2
Apr. 21, 2023 (DE) 10 2023 110 255.9

(51) Int. Cl. G01N 21/952; G01N 21/88; H04N 23/90

(52) U.S. Cl. CPC G01N 21/952; G01N 21/8851; H04N 23/90; G01N 2021/8887

(57) ABSTRACT

A test system for testing objects that are to be tested from all sides and have a position variance about a vertical axis, includes a motor-driven rotary plate that is rotatable about an axis of rotation and that can be temporarily introduced into a test area of the test system. Image capture devices present in the test area capture a plurality of reference images of a reference object in different positions of the rotary plate and stored in a processing unit. The rotary plate is removed and objects to be tested are tested.

The invention relates to an inspection system for visually inspecting all sides of matching objects with a positional variance about a vertical axis perpendicular to a standing surface of the objects to be inspected.

The objects to be inspected are for example irregularly shaped objects or cylindrical objects, such as yoghurt pots, threaded items, bottles or beverage closures with specific structures on the surface or lateral surface (for example folding hinge closures). The common feature of all these objects is that they have a vertical axis perpendicular to a standing surface about which they tend to rotate and thus change the appearance of the surface or lateral surface of interest for the inspection (positional variance about the vertical axis).

This positional variance about the vertical axis occurs for example when the objects to be inspected are supplied to the image capturing devices in an inspection area of the inspection system by a linear conveyor which forms a transport plane, wherein the objects stand by way of their standing surface on the transport plane.

When objects are inspected, the digital camera image represents a projected image of the object in two-dimensional space. The information about the position of the object in the third dimension is lost in this case. Known algorithms are capable of almost completely compensating for translational shifts, scaling and warping of the object occurring in the image plane (keyword: affine images). In contrast, changes in position which deviate from said degrees of freedom cause difficulties in the evaluation, these difficulties often being encountered by comparing an image stored as reference with the image of the object to be inspected.

The images cannot be matched for comparison by scaling, rotational and translational transformation. This problem can be encountered through local distortions (image warping) of the image in the case of small deviations, that is to say small positional variances about the vertical axis. However, larger deviations, that is to say large positional variances about the vertical axis, between the image of the object to be inspected and the reference image cannot be corrected.

WO 03/078928 A1 discloses a system for inspecting cylindrical objects, such as cans, using at least one digital camera which acquires images of a reference object in multiple rotational positions and the objects to be inspected. The inspection system comprises a processing line along which the objects to be inspected are conveyed in a manner vertically aligned with the vertical axis to an inspection station using a conveyor. The inspection station comprises the at least one camera and an object rotator arranged at the inspection station for rotating the reference object, wherein the reference object is imaged by the at least one camera while it is rotated in various positions in situ. The object rotator has a vertically movable object engagement element with a rubber cone or another end section which can engage with the object to be inspected but does not damage it. A processing unit is connected to at least one camera and the object rotator and creates a reference mask based on the images of the reference object in various rotated positions. An object to be inspected is imaged and a position mask is created. The processing unit compares the position mask for the object to be inspected with the reference mask in order to determine a position and/or defects of the object to be inspected.

Proceeding from this prior art, the invention is based on the object of providing an inspection system for inspecting all sides of objects to be inspected with a positional variance about the vertical axis by means of a multi-camera system, said system enabling the reference images required for the inspection to be produced with little effort over the extent of a reference object and also for those objects to be inspected which do not allow intervention in the object to be inspected.

This object is achieved by an inspection system having the features of claim 1.

The core idea of the invention is that the motor-driven rotary plate which can be rotated about an axis of rotation can be introduced only temporarily into the already existing inspection area of the inspection system. The reference object of the matching objects to be inspected is placed on the rotary table by way of the standing surface and a plurality of reference images of the reference object in different rotational positions of the rotary table are captured by means of the image capturing devices already available in the inspection area and are stored in a processing unit for the images.

The processing unit is designed to store the reference image set captured by means of the image capturing devices, that is to say the plurality of the reference images of the reference object captured in different rotational positions of the rotary table.

After the reference images have been captured, the rotary table is removed from the inspection area again and normal operation of the inspection system for capturing inspection images of the objects to be inspected can begin.

The number of reference images captured by the reference object in different rotational positions of the rotary table and thus angular positions of the vertical axis is determined in such a way that, regardless of the positional variance of the object to be inspected, the captured inspection image contains a respective reference image which corresponds to the captured inspection image as far as possible, since it was captured as the inspection image at a comparable position of the object. Due to the reference image being captured at a comparable position to the inspection image, the only slight distortions can be corrected using image-based techniques which are known per se, such as image warping, in order to align the images.

In order to reduce distortions between the reference images and the inspection images captured during normal operation, the parallel distance between the flat surface of the rotary plate and the transport plane is not more than 3 cm, preferably not more than 1 cm.

The inspection system according to the invention is suitable not only for inspecting matching cylindrical objects, like the closest prior art, but in particular also for inspecting matching irregularly shaped objects, as already mentioned at the outset. All of these objects have a vertical axis perpendicular to a flat standing surface. The flat standing surface enables the objects to be inspected to be placed on the transport plane of the linear conveyor in normal operation and the corresponding reference object to be placed on the flat surface of the rotary table. The objects to be inspected are preferably placed in normal operation along a center line which runs in the transport direction of the transport plane and is spanned by the linear conveyor. The reference object is preferably placed onto the surface of the rotary table approximately centrally, that is to say in such a way that the vertical axis of the reference object coincides with the axis of rotation of the rotary table.

In an advantageous embodiment of the invention, the linear conveyor is a belt conveyor. The belt conveyor is a motor-driven conveyor device which transports the objects to be inspected on a continuous conveyor belt running over deflection rollers. The continuous conveyor belt may be a conveyor belt with tension members, but may also be a link chain (modular belt). Link chains are particularly advantageous for the transport of packaged goods and are characterized by a high degree of flexibility.

The image capturing devices in the inspection area of the inspection system are digital cameras comprising grayscale and color cameras. To illuminate the objects to be inspected as well as the reference object, at least one light source may be arranged in the inspection area.

In order to counteract obstruction of object areas, the plurality of digital cameras around the object to be inspected in the inspection area are arranged above the transport plane. The plurality of digital cameras capture the objects to be inspected and the reference object from different perspectives. For example, a multi-camera system comprises 4 cameras, each arranged around the object in a manner offset by 90° from one another. The arrangement and number of cameras of the multi-camera system arranged around the object is determined in such a way that their recording ranges record all sides of each object to be inspected.

A preferred embodiment for the temporary introduction of the rotary plate into the inspection area results from the features of claim 7. In order to further reduce the distance between the surface of the rotary table and the transport plane, the preferred embodiment of the invention for the temporary introduction of the rotary table into the inspection area makes provision for three wheels arranged fixed at an even angular distance at a small distance above the transport plane to detect the outer edge of the rotary table, wherein one of the wheels is driven and one of the wheels can be moved away from the outer edge of the rotary table against the force of a spring element in order to be able to remove the rotary table after the reference images have been captured and to begin normal operation of the inspection system. The distance between the surface of the rotary table and the transport plane corresponds approximately to the thickness of the rotary table which is rotatably mounted about an axis of rotation with a minimum parallel distance from the transport plane between the three wheels.

The wheels are preferably in the form of grooved wheels. The circumferential groove positively accommodates the outer edge of the rotary table and may for example be in the form of a V-shaped slot. At least the drive wheel may have an adhesion-enhancing coating, in particular a friction lining, in order to transfer the drive forces to the rotary table without slip.

However, the wheels may also be in the form of gear wheels which interact with a gear ring arranged on the outer edge of the rotary plate. The transmission of the drive forces from the drive wheel in the form of a gear wheel to the ring gear is always without slip.

The reference images are preferably captured during a rotation of the rotary table, wherein the rotational speed of the rotary table, the trigger times and exposure times of the digital cameras are calibrated with one another. However, the reference images may also be captured when the rotary table is in a rest position.

Servo motors, usually DC or synchronous motors, are particularly suitable for steady rotation of the rotary table while the reference images are being captured.

If the reference images are to be captured when the rotary table is in a rest position, the driven wheel may be connected to a stepper motor in order to keep the rotational angle of the reference object constant between the reference images to be captured successively. The stepper motor connected to the wheel via a shaft enables the rotary table to be rotated gradually about its axis of rotation by a constant angle (step) without sensors for position feedback.

The processing unit of the inspection system is designed, after the reference images have been acquired from the reference image set, to determine the reference image which has the highest degree of matching with the captured inspection image of each object to be inspected. The best reference image can be determined by means of direct matching criteria between the images or indirectly via a parameter, for example an object edge or a marking on the lateral surface describing the positional variance of the object in the reference and inspection image.

After the reference image which has the highest degree of matching with the captured inspection image has been determined, the processing unit corrects any existing distortions between the captured inspection image and the determined reference image and aligns the two images. The aligned images are then compared with one another in order for example to identify defects in the surface of the object to be inspected and, if necessary, to remove defective objects downstream of the inspection area in the transport direction.

The invention is explained in more detail below with reference to an exemplary embodiment. In the FIGURE,

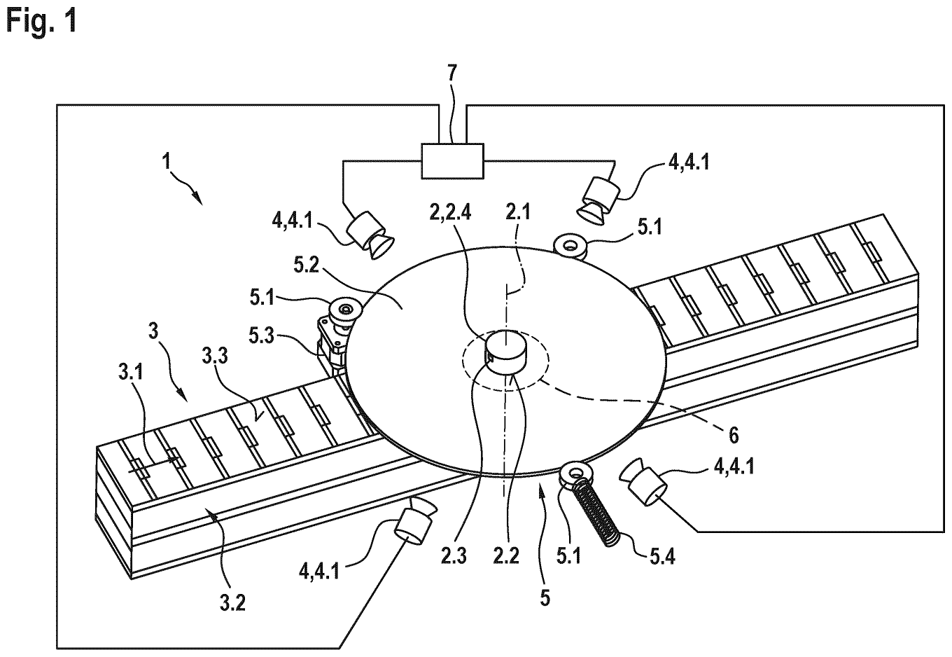

FIG. 1 shows a schematic partial view of an inspection system according to the invention for inspecting all sides of matching objects.

FIG. 1 shows a perspective view of a schematic partial view of an inspection system (1) according to the invention for visually inspecting all sides of matching objects (2). The objects (2) to be inspected are for example a cylindrical container with a vertical axis (2.1) perpendicular to a standing surface (2.2). A prominent marking (2.3), such as a symbol on a label or a barcode, is located on the lateral surface of the objects (2) to be inspected.

As essential components, the inspection system (1) comprises a linear conveyor (3), a plurality of image capturing devices (4) and a motor-driven rotary table (5) which can be rotated about an axis of rotation and which can be temporarily introduced into the inspection area (6).

In the exemplary embodiment illustrated, the linear conveyor (3) is a belt conveyor which transports the objects (2) to be inspected in the transport direction (3.1) through the inspection area (6) on a link chain (3.2) running over deflection rollers arranged on the end side.

The surface of the circumferential link chain (3.2) forms a transport plane (3.3) in the upper run of the linear conveyor (3). The flat standing surface (2.2) enables the objects (2) to be inspected to be placed on the transport plane (3.3) of the linear conveyor (3) in normal operation on the left-hand side of the inspection area (6) in the FIGURE and to be conveyed from the placement point through the inspection area (6). Even if all objects to be inspected can be placed at the placement point on the link chain (3.2) of the linear conveyor (3) with the marking (2.3) in exactly the same orientation, the objects (2) tend to rotate about the vertical axis (2.1) during transport, which is also referred to below as the positional variance of the objects to be inspected about the vertical axis (2.1). The positional variance changes the appearance of the objects to be inspected in an inspection image taken by an image capturing device (4) from a fixed perspective.

The four image capturing devices (4) in the inspection area (6) of the inspection system (1) are digital cameras (4.1). In order to counteract the obstruction of object areas of the objects to be inspected, the four digital cameras (4.1) are arranged around the object (2) in a manner offset by 90 degrees from one another. The digital cameras (4.1) are located in a plane which is arranged parallel above the transport plane (3.3) and the surface of the rotary plate (5) which can be temporarily introduced into the inspection area. The image capturing devices (4) are operatively connected to a processing unit (7), for example a personal computer, which is designed for storing and processing the captured images.

The image capturing devices (4) are designed for acquiring reference images of a reference object (2.4) of the objects (2) to be inspected and inspection images of the objects (2) to be inspected in an inspection area. The reference object is an object (2) which is perfect at least in relation to the inspection criteria.

In order to capture a plurality of reference images of the reference object (2.4) by means of the image capturing devices (4) and to store same as a reference image set in the processing unit (7), the rotary table (5) can be introduced into the inspection area (6) temporarily, in particular before the start of the controlled operation of the inspection system (1).

A preferred option for temporary introduction of the rotary table (5) is shown in FIG. 1). At a small distance, for example not more than 3 mm, above the transport plane (3.3), three wheels (5.1) are arranged fixed at an even angular distance of 120 degrees. The wheels (5.1) which are in the form of groove wheels positively accommodate the outer edge (5.2) of the rotary table (5). One of the wheels (5.1) is driven by a stepper motor (5.3), while the wheel (5.1) shown at the bottom of the FIGURE can be moved radially away from the outer edge (5.2) of the rotary table (5) against the force of a spring element (5.4) in order to be able to remove the rotary table (5) from the inspection area (6) after the reference images have been captured. For the sake of clarity, the axes of rotation of the wheels (5.1) and their fixed supports are not illustrated in FIG. 1. For the sake of clarity, the supports for the image capturing devices (4) are not illustrated either.

The stepper motor (5.3) connected to one of the wheels (5.1) makes it possible to rotate the rotary plate (5) about its axis of rotation gradually in defined increments, for example from 1-5 degrees, over a total of 90 degrees and to capture reference images using all image capturing devices (4) after each step, which results in reference images of all sides of the reference object (2.4) due to the total of four image capturing devices (4). The reference images captured in the different rotational positions by the image capturing devices (4) form a reference image set which is stored in the processing unit (7).

As an alternative, the rotary table is rotated continuously about its axis of rotation using a servo motor in order to capture reference images using all image capturing devices (4) in defined increments, for example from 1-5 degrees, during rotation, which results in reference images of all sides of the reference object (2.4) due to the total of four image capturing devices (4).

After the reference image set has been acquired, the rotary table (5) is removed and controlled operation of the inspection system begins. The processing unit (7) of the inspection system is designed in normal operation to determine from the reference image set the reference image which has the highest degree of matching with the inspection image of the object (2) to be to be inspected captured in the inspection area (6). In the exemplary embodiment illustrated, the best reference image is indirectly determined via a parameter, namely the marking (2.3) on the lateral surface, which describes the positional variance of the object (2) in the reference and inspection image.

After the reference image which has the highest degree of matching with the captured inspection image has been determined by the processing unit (7), the processing unit (7) corrects any existing distortions between the captured inspection image and the determined reference image and aligns the two images.

The aligned images are then compared with one another in order for example to identify a defect in the label of the objects (2) to be inspected and, if necessary, to remove objects (2) with defective labels downstream of the inspection area (6) in the transport direction (3.1) using means which are known per se, for example by means of compressed air.

| No. | Reference |
|---|---|
| 1. | Inspection system |
| 2. | Objects (to be inspected) |
| 2.1 | Vertical axis |
| 2.2 | Standing surface |
| 2.3 | Marking |
| 2.4 | Reference object |
| 3. | Linear conveyor |
| 3.1 | Transport direction |
| 3.2 | Link chain |
| 3.3 | Transport plane |
| 4. | Image capturing device |
| 4.1 | Camera |
| 5. | Rotary table |
| 5.1 | Wheels |
| 5.2 | Edge |
| 5.3 | Stepper motor |
| 5.4 | Spring element |
| 6. | Inspection area |
| 7. | Processing unit |

1.-12. (canceled)

13. An inspection system for inspecting all sides of objects to be inspected, the objects to be inspected being matching objects and having a positional variance about a vertical axis perpendicular to a standing surface, the inspection system comprising:
a linear conveyor configured to transport the objects to be inspected in a transport direction on a transport plane,
a plurality of digital cameras configured to capture reference images of a reference object of the objects to be inspected and inspection images of the objects to be inspected in an inspection area, wherein the plurality of digital cameras are arranged above the transport plane around each of the objects to be inspected within the inspection area in such a way that the plurality of digital cameras record all sides of the each of the objects to be inspected in the inspection area, and a motor-driven rotary table rotatable about an axis of rotation and which can be temporarily introduced into the inspection area, wherein
the distance between the surface of the rotary table and the transport plane is not more than 3 cm,
the reference object can be placed on the rotary table by way of the standing surface, and
a plurality of reference images of the reference object in different rotational positions of the rotary table are captured by the digital cameras and stored in a processing unit when the reference object is placed on the rotary table by way of the standing surface and the rotary table is introduced into the inspection area.

14. The inspection system as claimed in claim 13, wherein the objects to be inspected are irregularly shaped or cylindrical.

15. The inspection system as claimed in claim 13, wherein the linear conveyor is a belt conveyor.

16. The inspection system as claimed in claim 13, wherein the parallel distance between the flat surface of the rotary plate and the transport plane is not more than 1 cm.

17. The inspection system as claimed in claim 13, further comprising three wheels that are fixedly arranged above the transport plane and hold the outer edge of the rotary table, wherein one of the wheels is driven and another of the wheels is movable away from the outer edge of the rotary table against the force of a spring element to allow removal of the rotary table from the inspection area after the reference images have been captured.

18. The inspection system as claimed in claim 17, wherein the driven wheel is connected to a stepper motor or a servo motor.

19. The inspection system as claimed in claim 17, wherein the wheels are grooved wheels.

20. The inspection system as claimed in claim 17, wherein the wheels are in the form of gear wheels which interact with a gear ring arranged on the outer edge of the rotary plate.

21. The inspection system as claimed in claim 13, wherein the processing unit is further designed to determine, for each of the objects to be inspected, a determined reference image from the plurality of reference images that has the highest degree of matching with the captured inspection image of the each of the objects to be inspected.

22. The inspection system as claimed in claim 21, wherein the processing unit is further designed to correct distortions between the captured inspection image of the each of the objects to be inspected and the determined reference image and to align the two images.

23. The inspection system as claimed in claim 17, wherein the three wheels are arranged to hold the outer edge of the rotary table at even angular distances.
